(19) United States
(12) Patent Application Publication
(10) Pub. No.: US 2021/0296819 A1
(43) Pub. Date: Sep. 23, 2021

(54) DISCONNECTING AND SUPPORTING QUICK RELEASE ELECTRICAL FIXTURES

(71) Applicant: Ran Roland KOHEN, Aventura, FL (US)

(72) Inventor: Ran Roland KOHEN, Aventura, FL (US)

(21) Appl. No.: 17/087,730

(22) Filed: Nov. 3, 2020

Related U.S. Application Data
(63) Continuation of application No. 16/605,994, filed on Oct. 17, 2019, now Pat. No. 10,826,236.
(60) Provisional application No. 62/486,132, filed on Apr. 17, 2017.

(51) Int. Cl. H01R 13/627; H01R 24/66; H01R 24/76

(52) U.S. Cl. CPC H01R 13/6276; H01R 24/76; H01R 24/66

(57) ABSTRACT

A plug is connectable to an electrical socket which has concentric ring shaped openings housing electrical contacts. The plug has a body supporting electrically conductive concentric rings insertable into the socket to contact the electrical contacts to form electrical connections. A hollow post extends away from the plug body and has a transverse aperture therethrough. A rod with a narrowed portion is slideable within the post. A spring biases the rod towards a latched position in which the narrow portion is not adjacent to the transverse aperture. A cross-brace is connected to a portion of the rod which extends outside of the post. Pins engage the cross brace and can be pushed to move the brace, and thereby push the rod to position the narrowed portion to an unlatched position adjacent the aperture to enable removal of the plug.

### CROSS REFERENCE TO RELATED APPLICATIONS

This disclosure relates to PCT International Patent Application No. PCT/US2016/032170 filed May 12, 2016 (published as WO 2016/183354 A1); U.S. Pat. No. 7,462,066 filed Mar. 20, 2007; U.S. Pat. No. 7,192,303 filed Dec. 2, 2004; and U.S. Pat. No. 6,962,498 filed Dec. 12, 2001; and to U.S. Patent Application Publication No. 2009/0280673 filed Dec. 2, 2005; U.S. Provisional Applications 62/160,585 filed May 12, 2015; 62/308,718, filed Mar. 15, 2016; 62/467,176 filed Mar. 5, 2017; and 62/470,170 filed Mar. 10, 2017; the contents of all of which are hereby incorporated by reference herein, in their entirety.

### FIELD OF THE DISCLOSURE

The disclosure relates to a system and method for securely connecting suspended electrical fixtures without tools, and in particular, by a connection including a push-button mechanism which does not interfere with centrally mounted fixtures.

### BACKGROUND OF THE DISCLOSURE

Traditional techniques for installing electrical fixtures and appliances, such as lighting fixtures and fans on walls or ceilings usually require the assistance of a qualified electrician, and the use of a variety of tools and specialized hardware. The procedure for installing or uninstalling such fixtures can also be relatively time consuming, even when carried out by an experienced installer. In addition to the need for hand-wiring the necessary electrical connections between the fixture and electrical power supply wiring, the installer must make separate mechanical connections for supporting or suspending the fixture in place.

### SUMMARY OF THE DISCLOSURE

In an embodiment of the disclosure, a plug useable with an affixed electrical socket having a body forming a plurality of concentric ring shaped openings terminating in electrical contacts, comprises a body; a plurality of electrically conductive concentric rings insertable within the plurality of concentric ring shaped openings of the socket to thereby form electrical connections with the electrical contacts of the socket; a hollow post extending from the body at the center of the concentric rings, the post having an aperture extending therethrough and being transverse to a longitudinal axis of the post; a rod slideably having a portion extending within the hollow post, and an end extending outside the post, the rod including a narrowed portion, the rod slideable between a release position in which the narrowed portion is adjacent the aperture and a latched position in which the narrowed portion is away from the aperture; a spring connected to the rod and the body to bias the rod towards the latched position; an elongate cross-brace connected to the rod end at a rod connection location and having opposed brace ends positioned away from the rod connection location; two elongate pins, each connected to an opposed brace end to extend away from the cross-brace, whereby when the elongate pins are moved, the cross-brace is caused to move, whereby the rod is slideably moved within the post, against the bias of the spring, from the latched position to the release position.

In variations thereof, the pins extend from the body to form button shapes which are pressable by a user of the plug; the device further includes balls positioned within the aperture, whereby when the rod is in the latched position, the balls are pushed within the apertures to extend at least partially beyond an outer circumference of the post, and when the rod is in the release position, the balls are pushable to be positioned entirely within the outer circumference of the post and partially within the narrowed portion of the rod; the device further includes a second aperture positioned away from the aperture and extending through the post and being transverse to a longitudinal axis of the post; and/or the immediately foregoing variation, wherein the second aperture is radially offset 90 degrees from the aperture.

In further variations thereof, the device further includes a base positioned between the rod and the cross-brace; the cross-brace further includes an aperture formed into each of the opposed ends of the cross-brace, each sized to receive a portion of a pin; the body includes a central aperture axially aligned with the rod and forming a pathway dimensioned for passage of an electrical cable when an electrical cable is inserted into the central aperture; and/or the central aperture includes a bend at a location away from the central aperture, the bend sized for passage of the electrical cable, when an electrical cable is inserted through the central aperture and bend.

In additional variations thereof, the post is connected to a body having a round threaded portion, the threaded portion including a flattened side portion; and/or the pins having opposed ends not connected to the cross-brace, the opposed ends mutually connected by a loop, the loop pushable to simultaneously push both pins.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a front perspective view of a socket useable together with plug/spindle assemblies of the disclosure;

FIG. 2 is a back perspective view of the socket of FIG. 1;

FIG. 3 is back perspective view of a spindle assembly of the disclosure;

FIG. 4 is front perspective view of a spindle assembly of the disclosure;

FIG. 5 is a central cross-section of the spindle assembly of FIG. 4, together with a mounted canopy;

FIG. 6 is a perspective view of the spindle assembly and canopy of FIG. 5;

FIG. 7 is a back view of the spindle assembly and canopy of FIG. 5;

FIG. 8 is a central cross-section of the spindle assembly and canopy of FIG. 4, illustrating additional elements;

FIG. 9 is a cross-section of the spindle assembly of FIG. 8, rotated 90 degrees;

FIG. 10 is a cross-section of the spindle assembly of FIG. 4;

FIG. 11 is a perspective front view of the spindle assembly of FIG. 4, mounted to a canopy;

FIG. 12 is an exploded view of the spindle assembly of FIG. 4;

FIG. 13 illustrates various fixture attachment methods useable with the spindle assembly of FIG. 4;

FIG. 14 illustrates a cross section of a portion of the spindle assembly of FIG. 4, including a loop affixed to release pins;

FIG. 15 is an exploded view of the spindle assembly of FIG. 4;

FIG. 16 is a central cross-section through the spindle assembly of FIG. 15;

FIG. 17 is a central cross-section through an alternative spindle assembly of the disclosure, including apertures and captive balls offset 90 degrees;

FIG. 18 depicts the spindle assembly of FIG. 17 in a release position, and further illustrates a combination with a dual release pin configuration of the disclosure;

FIG. 19 is a central cross-section of a post component of the spindle assembly of FIG. 17;

FIG. 20 is a side view of the spindle assembly of FIG. 17; and

FIG. 21 is a bottom end view of the spindle assembly of FIG. 17.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Previous disclosures of the inventor, cited above, describe a flexible socket which admits a plug for conducting electric power to a light, fan or other suspended fixture. The plug mechanically supports the weight of the fixture, in a desired orientation, to that the fixture can also receive power from the plug. A central releasable latching mechanism allows partial or total withdrawal of the plug. Partial withdrawal is used to support the weight of the fixture while a change is made to the rotational orientation of the fixture. Total withdrawal is used to transfer the fixture to another location.

A “quick connect device” for installing electrical fixtures comprises the combination of a plug and mating socket. The plug and mating socket of the device function to both establish an electrical connection between an electrical fixture and electrical supply wiring, and mechanically support the fixture on a surface or base, typically a wall, ceiling or floor surface. As used herein, the term “fixture” or “electrical fixture” means any fixture or appliance such as a lighting fixture, ceiling fan, television camera, security device or any other device which is powered by electricity supplied by electrical wiring, and which requires a mechanical connection to support or suspend the fixture. The plug is fixedly secured to an electrical fixture, while the socket is secured to either the surface (e.g., wall, ceiling or floor) on which the fixture is to be mounted, or to an electrical junction box. The structure, function, and operation of the plug and mating socket have already been detailed in, for example, the patents and application incorporated by reference herein, and reference may be had thereto for details regarding the quick release fixture generally, as well as to variations thereof which can all be used in combination with the disclosure.

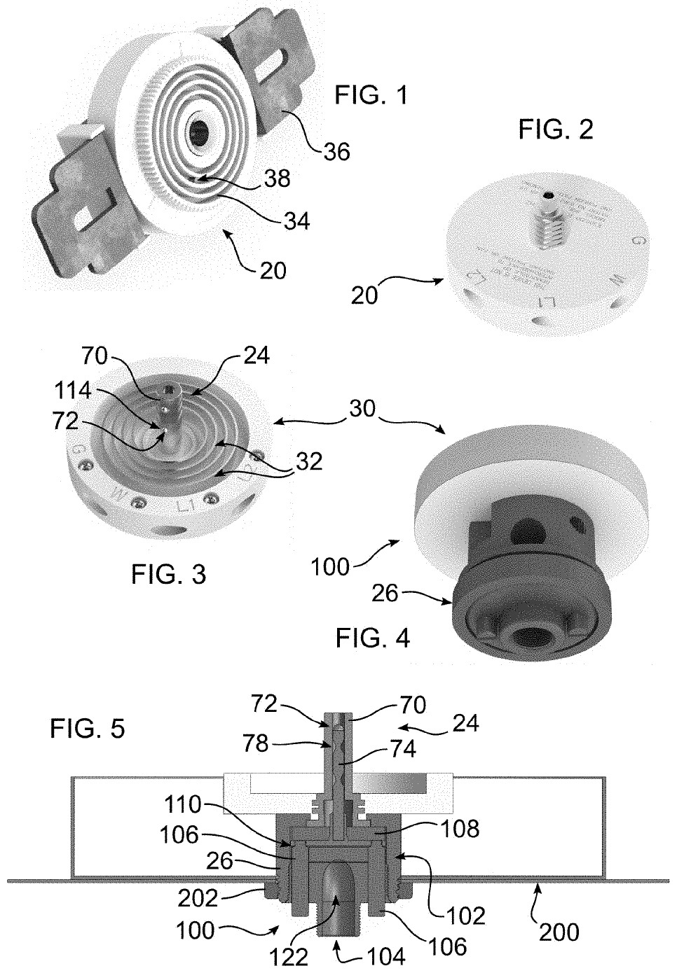

Referring generally to FIG. 1-5, a socket 20 of a quick connect device for installing electrical fixtures receives a plug 30, thereby forming an electrical connection between socket 20 and plug 30. In FIG. 1, socket 20 is attached to a bracket 36 which is configured for mounting to a standard electrical box. In accordance with the disclosure, a combination device 100 is configured and dimensioned to mate with socket 20. Combination device 100 includes a spindle assembly 24 as described in the incorporated references, which is used to releasably mechanically connect plug 30 to socket 20. Combination device 100 also includes a body 26 having, on a first side, concentric, male connector rings 32, which may be integrally molded into the body 26 if molded from a non-conductive material. Rings 32 have sufficient radial spacing therebetween to electrically insulate them from each other. The diameters and spacing of the male connector rings are such that they are alignable with and receivable within corresponding female recesses 34 in the socket 20, to make contact mating conductors 38 within socket 20. As detailed in the patent publications incorporated by reference, this alignment is used to electrically connect the plug 30 to the socket 20, thereby establishing an electrical connection between an electrical fixture and electrical supply wiring, and mechanically supporting the fixture on a surface or base, typically a wall, ceiling or floor surface.

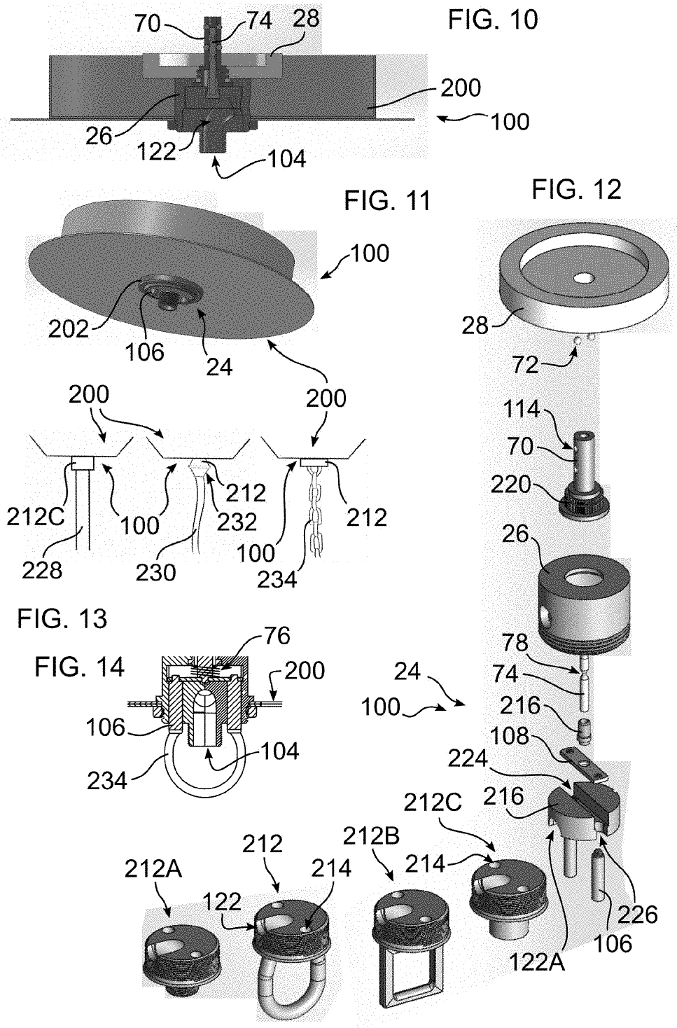

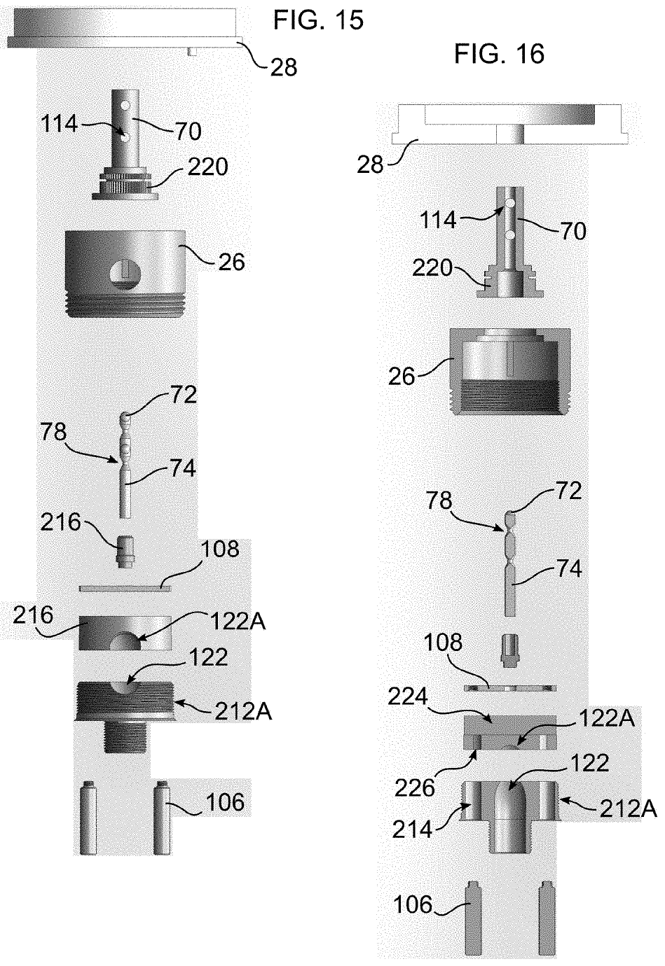

With reference to FIGS. 4-12, a two-pin release mechanism 102 enables detachment of device 100 while leaving an unobstructed central area 104, through which an electrical cable, support pole, or other object can pass and/or connect to device 100. Pins 106 can be pressed by thumbs while the fingers of each hand grasp body 26, to disconnect spindle assembly from socket 20 and release device 100. In the embodiment shown, device 100 is connected to a canopy 200 by a threaded ring 202. Accordingly, canopy 200 can be grasped by the fingers to support the weight of device 100, canopy 200, and any attached fixture, while both pins 106 are pressed to release device 100.

More particularly, pins 106 slidably extend through body 26 or through a pin aperture 214 within a fixture attachment element 212 (FIG. 12). In the figures, pin 106 forms an elongated shaft, however it should be understood that pin 106 could be implemented as a separate button extending to an exterior of device 100 which is in turn attached to a shaft which passes through aperture 214. A cross-brace 108 connects ends 110 of pins 106 and engages release rod 74.

A spring 76 (shown in FIGS. 14 and 17-18) biases rod 74 to position recesses 78 away from balls 72 to maintain balls 72 trapped within apertures 114 (see FIGS. 12-14) within post 70, thereby preventing withdrawal of post 70 from cylinder 68 of socket 20 due to interference between balls 72 and cylinder 68. When pins 106 are pressed against the bias of spring 76, rod 74 is moved to align recesses 78 with balls 72, thereby allowing balls 72 to move out of interference with cylinder 68, enabling withdrawal of post 70 from cylinder 68, and thereby removal of device 100 from socket 20.

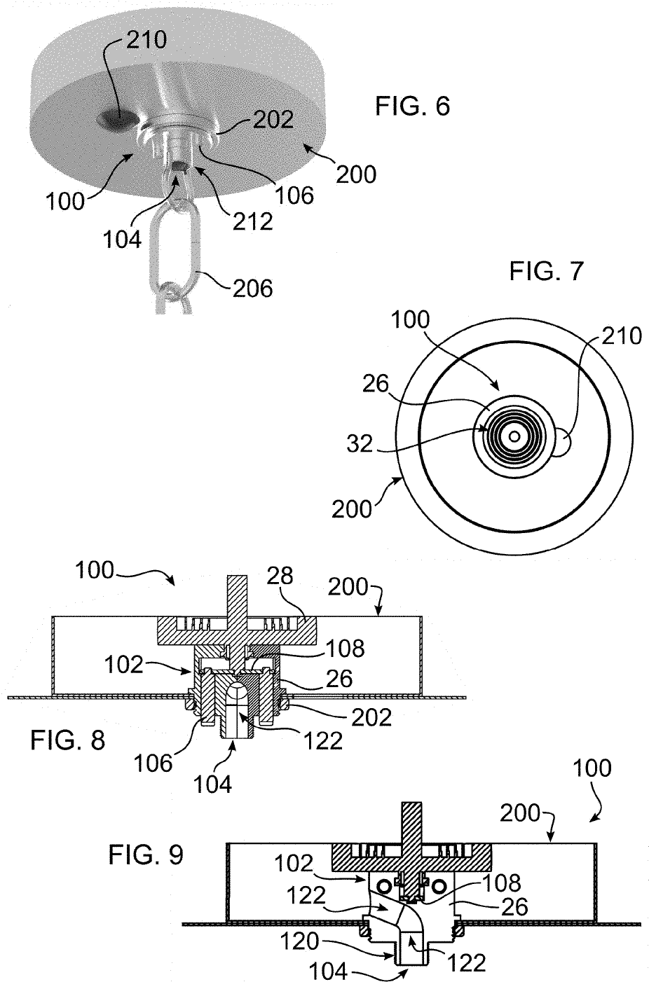

FIG. 6 depicts a swage or pendant light fixture, where a fixture attachment 212 including a chain 206 is affixed to device 100 by a threaded connection formed with an externally threaded end 120 of base 26. A wire conductor, not shown, passes through central area 104 into an interior of canopy 200, where appropriate electrical connections can be made. In this embodiment, canopy 200 includes a sensor 210 of a type selected for detecting a particular desired ambient condition, as detailed in the incorporated references. FIG. 7 depicts the embodiment of FIG. 6, as viewed from the top or installation end. FIGS. 8 and 9 are cross-sections of FIG. 7, taken 90 degrees apart, wherein an internal pathway 122 for a conductor wire can be seen.

In FIG. 12, four alternative fixture attachment elements are shown, including the chain type attachment element 212 of FIG. 6, an externally threaded stud 212A, an internally threaded stud 212C, and a square link 212B, any of which can be threaded into body 26, or affixed to body 26 by any other means. FIG. 12 additionally depicts pin apertures 214 which slideably support pins 206. Post 70 is inserted into a post receiver 216, and receiver 216 is in turn inserted into cross-brace 108. Body 26 forms a fixture attachment receiver for threadably connecting fixture attachment element 212, and supports a canopy 200, if present. A cross-brace guide 222 includes a cross-brace channel 224 which aligns and guides cross-brace 108, and which further includes pin guides 226, and which forms a portion 122A of internal pathway 122. Post 70 includes a post base 220 which engages receiver 218. Post 70 passes through receptacle base 28.

In FIG. 13, three styles of fixture attachment are illustrated. At left, a rod 228 is attached, for example by threading onto or into fixture elements 212A or 212C, respectively. An electrical wire can be passed through rod 228 to a remainder of the fixture. This type of attachment can work for a sconce or floor standing fixture, as well as a suspended fixture. In the center, a flexible electrical cable 230 is connected to a grommet or strain relief 232 which is connected to fixture element 212. At right, a chain 234 extends from fixture element 212. Examples fixture which can thus be attached include pendants, chandeliers, semi-flushmount fixtures, and emergency or exit signs.

FIG. 14 illustrates one embodiment in which a first link 234 of a chain is connected at each opposite end to a pin 106, whereby a connected fixture can be released by pushing up on first link 234, and while pushing up, separating the fixture from socket 20.

Device 100 including plug 30 provides an instant plug-and-play platform for light fixtures and ceiling fans. Device 100 can be integrated into lighting or other electrical fixtures during the manufacturing process. Device 100 includes two push-buttons (pins 106) that are pushed to enable locking a fixture in place while simultaneously forming electrical contacts to provide the fixture with power. Pins 106 can be pushed again to enable releasing of the fixture while safely disconnecting the electrical connections. By providing two pins 106 which flank a centrally disposed opening 104, many fixtures which require or benefit from a central mounting point and electrical connection can be easily connected and disconnected.

As such, consumers can safely install and replace electrical fixtures with a simple push and click. Socket 20 is installed into a standard lighting junction box and provides both power and mechanical support to any fixture equipped with device 100. Socket 20 is installed by inserting electrical wires of the facility into wire traps, and then further securing the wires with screw clamps. Where socket 20 is provided with an appropriate bracket, the bracket is then secured into the junction box with two screws. A simple and attractive cover plate is connected to socket 20 to cover any wall box and unfinished surfaces, completing the final installation and providing a tidy appearance. The receptacle thus configured is safe to touch, even when the power is on, and avoids a risk of electrical shock.

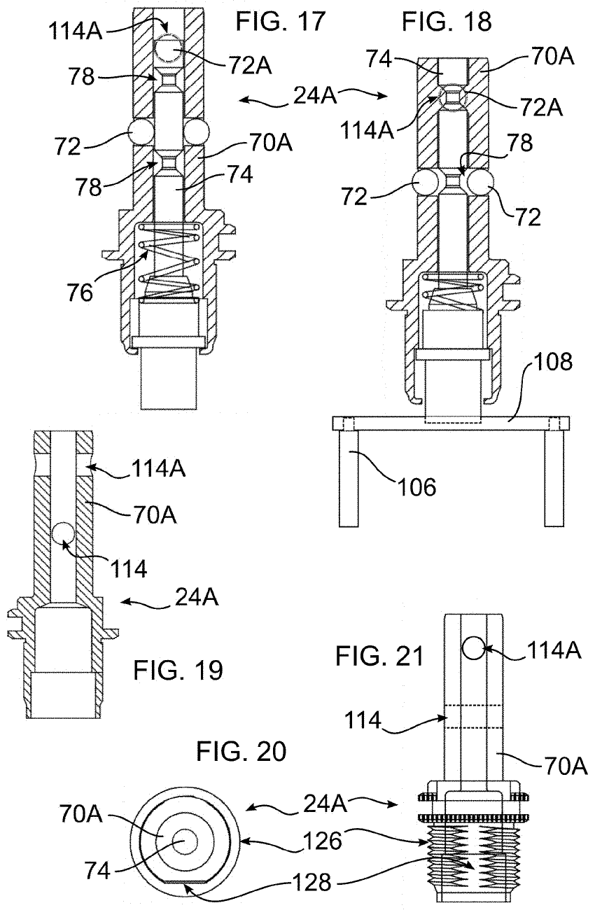

Referring now to FIGS. 17-21, an alternative spindle assembly 24A which can be incorporated into device 100 in place of spindle 24, and which can be substituted for other spindle assemblies in the incorporated references. Spindle assembly 24A includes a post 70A formed with at least two apertures 114, 114A for passage of balls 72, however at least two of the apertures 114, 114A are radially offset 90 degrees with respect to each other. In this manner, by offsetting apertures 114, 114A, the likelihood of a failure along the longitudinal linear axis of rod 74 or post 70A is reduced, as there are fewer bore holes along a particular linear axis. Additionally, any axially extending defect in post 70A or rod 74 which causes a failure of one of aperture 114 or 114A does not necessarily result in a mechanical failure of spindle assembly 24A which might otherwise result in an inability of spindle assembly 24A to continue to support an attached fixture. Further, apertures 114 and 114A continue to cooperate to provide a cumulatively greater pull-out strength of spindle assembly 24A.

In FIG. 18, cross-brace 108 and pins 106 are shown, to clarify that spindle assembly 24A can be used in other embodiments of the disclosure.

FIG. 19 illustrates a bisecting cross-section of FIG. 17, with rod 74 removed. FIGS. 20 and 21 depict spindle assembly 24A removed from device 100. A flattened profile 128 is provided upon a round portion of base 126, which can be threaded, the flat portion mateable to a corresponding flattened area provided upon a mounting point for spindle assembly 24A, such as a fixture, canopy, or mounting bracket to which spindle assembly 24A is to be mounted, thereby keying spindle 24A to a particular radial orientation with respect to the fixture or mounting point.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A plug useable with an affixed electrical socket having a body forming a plurality of concentric ring shaped openings terminating in electrical contacts, the plug comprising:
a body;
a plurality of electrically conductive concentric rings insertable within the plurality of concentric ring shaped openings of the socket to thereby form electrical connections with the electrical contacts of the socket;
a hollow post extending from the body at the center of the concentric rings, the post having first and second apertures extending therethrough and being transverse to a longitudinal axis of the post, with the first aperture and second aperture being spaced from each other and the second aperture radially offset 90 degrees from the first aperture;
a rod slideably having a portion extending within the hollow post, and an end extending outside the post, the rod including a narrowed portion, the rod slideable between a release position in which the narrowed portion is adjacent the aperture and a latched position in which the narrowed portion is away from the aperture;
a spring connected to the rod and the body to bias the rod towards the latched position;
a first set of balls positionable within the first aperture, whereby when the rod is in the latched position, the first set of balls is pushed within the first aperture to extend at least partially beyond an outer circumference of the post, and when the rod is in the release position, the first set of balls is pushable to be positioned entirely within the outer circumference of the post and partially within the narrowed portion of the rod;
a second set of balls positionable within the second aperture, whereby when the rod is in the latched position, the second set of balls is pushed within the second aperture to extend at least partially beyond an outer circumference of the post, and when the rod is in the release position, the second set of balls is pushable to be positioned entirely within the outer circumference of the post and partially within the narrowed portion of the rod.

2. The plug of claim 1, further comprising an actuator operatively associated with the rod such that actuation of the actuator slideably moves the rod within the post against the bias of the spring from the latched position to the release position.

3. The plug of claim 2, wherein the actuator is connected to the rod end at a rod connection location.

4. The plug of claim 1, wherein the first set of balls comprises two balls.

5. The plug of claim 4, wherein the second set of balls comprises two balls.

6. The plug of claim 1, the body including a central aperture axially aligned with the rod and forming a pathway dimensioned for passage of an electrical cable when an electrical cable is inserted into the central aperture.

7. The plug of claim 6, wherein the central aperture includes a bend at a location away from the central aperture, the bend sized for passage of the electrical cable, when an electrical cable is inserted through the central aperture and bend.
